(19) United States
(12) Patent Application Publication
(10) Pub. No.: US 2015/0261425 A1
(43) Pub. Date: Sep. 17, 2015

(54) OPTIMIZED PRESENTATION OF MULTIMEDIA CONTENT

(71) Applicant: APPLE INC., CUPERTINO, CA (US)

(72) Inventors: DANIEL E. MARUSICH, SAN CARLOS, CA (US); DAVID MAKOWER, MILPITAS, CA (US); HOWARD FISHMAN, SAN FRANCISCO, CA (US); NIKOLAY UGLOV, SAN FRANCISCO, CA (US)

(73) Assignee: APPLE INC., CUPERTINO, CA (US)

(21) Appl. No.: 14/214,650

(22) Filed: Mar. 14, 2014

(51) Int. Cl. G06F 3/0484; G11B 27/34; G06F 3/0481

(52) U.S. Cl. CPC G06F 3/04847; G06F 3/0481; G11B 27/34

(57) ABSTRACT

Methods and arrangements are provided for the optimized configuration of media bundles to facilitate media presentations on client devices. In particular, media bundles are submitted by content providers for displaying media presentations associated with a video or audio product. The media bundles can contain instructions for presenting content, as well as digital media assets for use in media presentations. The media bundles are then optimized for the formatting and presentation of media content based on the unique display and usage characteristics of the client device, and are displayed on the client device in the optimized fashion.

### TECHNICAL FIELD

The present technology pertains to the optimized configuration of media bundles; and more specifically pertains to media bundles that can be presented according to the unique characteristics of client devices.

### BACKGROUND

There are many popular methods for distributing video media content in physical form, such as DVDs and Blu-Ray discs. Such physical discs can be purchased or rented either from physical stores or online stores. Often, DVD and Blu-Ray discs contain not only an electronic file containing media content (e.g., a feature-length film), but also interactive media portions that serve various uses. In some instances, the interactive media portion provides introductory multimedia effects, in addition to a menu for navigating the content of the DVD. Such menus enable the user to make a menu selection by entering inputs into the playback device. Other interactive portions can be triggered by navigating through the menu. For example, a disc may contain media content relating to deleted scenes, audio commentary tracks, concept art galleries, and more.

Conventionally, content providers have been able to submit digital media assets under their control to an online media distribution site for further distribution. In recent years, advanced online media distribution sites, such as the iTunes Store maintained by Apple Inc., of Cupertino, Calif., have permitted online submission of digital media assets, such as songs, movies, television shows and application programs, to the online media distribution site. In some online media distribution sites, there is the ability for a content provider to provide support for interactive media functionality, including menus and extra content, as is available with DVDs and Blu-Ray discs. In such instances, when a downloaded video is played on a compatible playback device or playback software, the interactive media content appears, including introductory multimedia effects, menu navigation, extras and more. The content provider may provide this interactive content within a fixed media bundle, containing specific instructions for precisely how the menus and other content are displayed and formatted. The instructions might be written in HTML, Javascript, or other languages and include specific instructions for the presentation and navigation experience.

Online media distribution and media playback applications also allow for possibilities that extend beyond the functionality of DVDs and Blu-Ray discs. For example, dynamic content related to a piece of media, available on the media distribution site, may be presented to a user. This would not have been possible with media that exists solely on disc. Another example is the ability to continually update, improve and enhance media experiences even after a user has downloaded a piece of media.

However, users today access digital media and video across a wide range of devices. While some may resemble the experience that content providers typically design for, such as a desktop computer or laptop computer, other devices may provided limited screen space and different user input configurations. For example, a phone or tablet might have less screen space than a desktop with monitor, and may be interacted with primarily via user touch gestures. When users with such devices download and play back digital media, the interactive portions and menus may be suboptimal for the navigation and screen demands of that device.

### SUMMARY

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology can optimize the configuration of media bundles to facilitate media presentations according to the unique characteristics of client devices. A media presentation can be a collection of content arranged in a way that can be interacted with by a user operating a client device. A media presentation may be presented for playback through a media player application. Each media presentation is typically associated with a digital media asset, such as a feature-length film that may take the form of a digital video file. Each media presentation typically includes a menu that can be interacted with and navigated by the user, and the menu may include a menu structure with one or more layers of submenus. Navigating through and selecting one menu item may reveal a submenu with additional menu items and interactive content. In some embodiments, a media presentation may begin with introductory content, such as an introductory video that plays prior to the menu content. In some embodiments, a media presentation may appear different to users in specific geographic regions, depending on region-specific content that a content provider has specified depending on location. One example may be the default language that is displayed for users within a specific region.

Media presentations are facilitated through media bundles. A media bundle is a series of digital files which can include or identify various digital media items for use in the media presentation, and can provide computer executable instructions for controlling the media presentations. The resulting media presentations can provide multimedia experiences for users of client devices in different geographic regions.

The media bundles are optimized for the formatting and presentation of media content based on the unique display and usage characteristics of a user's client device. The optimized content can then be presented to the user via the user's client device. Disclosed are systems, methods, and non-transitory computer-readable storage media for implementing the approaches of the present technology.

The instructions that are submitted by a content provider in a media bundle can take the form of a formatted document that specifies a series of elements set within an ordered hierarchy. The elements collectively define metadata that describes each piece of the interactive media content, where it belongs, and more. The elements can specify menu structure, set global parameters, define extras content such as image and video galleries, designate content to certain geographic regions, and more. These instructions conform to a standard “specification” for the content providers to submit interactive media content along with their video or media product that can be interpreted by a server or client device to understand the nature of the content provided, and render the content in an appropriate manner for the respective device on which the content may be displayed.

Once the specification has been submitted by the content providers along with the digital media items required for the media presentation, a media presentation can be optimized and prepared for a user based on the specification instructions and digital media items. In some embodiments, the optimization of a media presentation can be performed automatically by a system or playback application configured to do so, performed by a cloud based server, or some combination of both. Each optimization takes into account the unique characteristics of a different client device. Some characteristics that can be taken into consideration are screen dimensions, screen space, types of user input available, and processor power.

One embodiment of the present technology can involve hosting the specification instructions and digital media assets within a cloud server architecture. Instead of a client device downloading and storing the media presentation content, it can be served to the client device from a remote server as various pieces of content are requested.

Another embodiment of the present technology can involve time-based data being specified in specification instructions and used within media presentations. Such time-based data may identify objects, locations, characters, and other aspects of video content that are configured to appear on the screen at a given time or within a given scene. This metadata can be used for different purposes such as searching for particular scenes or delivering extra content that is relevant to the scene.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary method embodiment;

FIG. 3 illustrates an exemplary method embodiment;

FIG. 4A and FIG. 4B illustrate exemplary elements and an element hierarchy;

FIG. 5 illustrates an example instruction set;

FIG. 6 illustrates example rootnode instructions;

FIG. 7 illustrate

FIG. 8A and FIG. 8B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for an efficient means to present interactive media content for videos and other media files in an online media distribution site, in a way that is optimized for each users' client device. The disclosed technology provides users with menus, supplemental content and other content often associated with video files, such as professionally produced movies. Such content can be referred to as a title, for example a movie title refers to a movie (e.g., the movie title Wall-E, refers to the movie “Wall-E”), and the supplemental content can be considered the additional content, beyond the actual movie, that is commonly found on DVD's and Blu-Rays, or distributed by the Apple iTunes online media store as “iTunes Extras.” The title is not limited to movies; a title can be a song, album, book, or any other media content offering for which it is desired to provide supplemental content. The supplemental content can be presented in a flexible way that allows for multiple different presentation schemes and layouts based on the capabilities of a computing device or geographic region restrictions pertaining to a geographic region in which a computing device is located. The disclosed technology also providers content providers with a simple, efficient way to specify menus and extra content without having to focus on end-user presentation, display and interface concerns.

In particular, the present technology is directed to systems, methods, devices, and non-transitory computer-readable storage media providing for the optimized configuration of media bundles to facilitate media presentations according to the unique characteristics of client devices.

Prior to discussing the present technology in detail, a brief introductory description of an exemplary configuration of devices and a network is disclosed herein. A detailed description of the various aspects of the present technology will then follow. These variations shall be described herein as the various embodiments are set forth.

In one embodiment of the present technology, a media bundle once created can be electronically submitted to a network-based media distribution system. The network-based media distribution system can validate and approve a submitted media bundle for distribution. For example, once approved, the submitted media bundle can be made available for acquisition at an online media store. Users of client devices are thereafter able to access the online media store via a network and acquire a digital media asset and its associated media bundle. If acquired, the digital media asset and the associated media bundle can be electronically delivered to the client device for presentation. In some embodiments, the digital media asset and the associated media bundle can be stored at the client device.

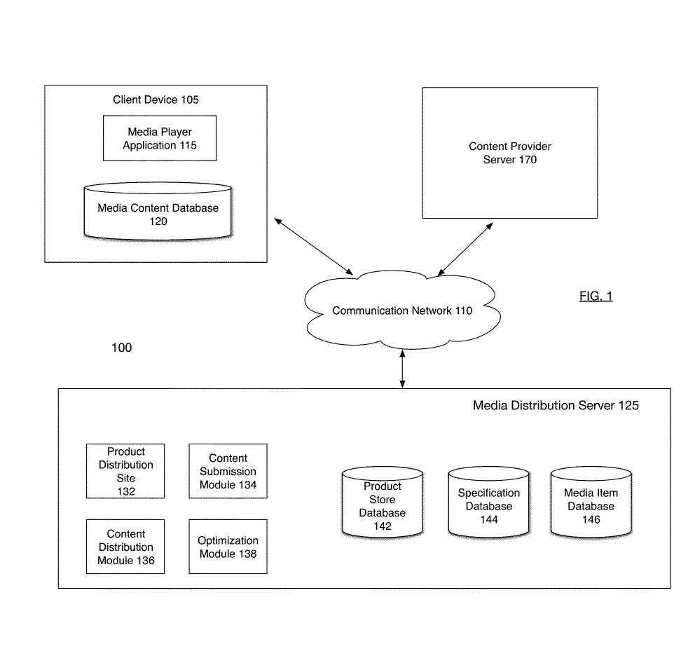

FIG. 1 illustrates an exemplary system configuration 100 in which multiple computing devices can be configured to communicate with each other to create and perform a media presentation on a client device. Within the exemplary system configuration 100, multiple computing devices and servers can be connected to a communication network 110 and can be configured to communicate with each other through use of the communication network 110. The communication network 110 can be any type of network, including a local area network (“LAN”), such as an intranet, a wide area network (“WAN”), such as the internet, or any combination thereof. Further, the communication network 110 can be a public network, a private network, or a combination thereof. The communication network can also be implemented using any type or types of physical media, including wired communication paths and wireless communication paths associated with one or more service providers. Additionally, the communication network 110 can be configured to support the transmission of messages formatted using a variety of protocols.

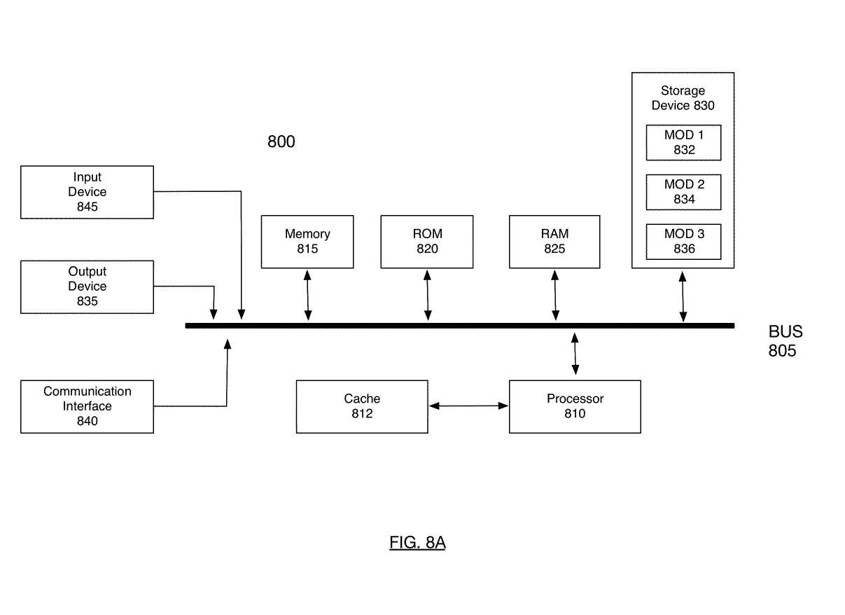

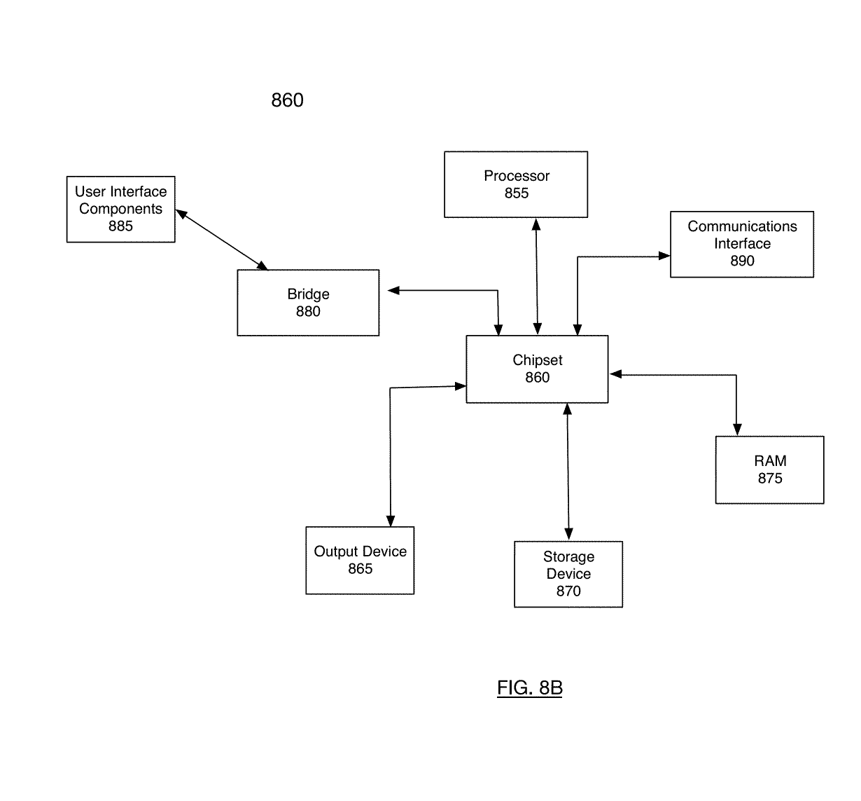

A client device 105 can be any type of general computing device capable of network communication with other computing devices. For example, the client device 105 can be a personal computing device such as a desktop or workstation, a business server, or a portable computing device, such as a laptop, smart phone, or tablet personal computer. The client device can include some or all of the features, components, and peripherals of computing device 800 of FIG. 8.

To facilitate communication with other client devices, the client device 105 can also include a communication interface configured to receive a communication, such as a request, data, etc., from another computing device in network communication with the client device 105 and pass the communication along to an appropriate module running on the client device 105. The communication interface can also be configured to send a communication to another computing device in network communication with the client device 105.

As illustrated, a client device 105 can be configured to communicate with a media distribution server 125 to receive and perform media content and media presentations on the client device 105. For example, a media player application 115 running on the client device 105 can be configured to communicate with a product distribution site 132 on the media distribution server 125 to request, receive and perform media content and media presentations. A media player application can be any application capable of media item playback, such as a component of a webpage, a plug-in, a client-side application, etc.

The exemplary system configuration 100 includes a media distribution server 125. The media distribution server 125 includes a product distribution site 132 that provides an online access point for distribution of various digital products. For example, the product distribution site 132 can be referred to as an online store, while the media distribution server 125 is the server with modules and databases necessary for the online store to operate. A content submission module 134 operates to receive submissions of digital products from a content provider through a content provider server 170. The content submission module 134 can process submission of digital products and authorize distribution of approved digital products.

The digital products can be stored in a product store database 142. The product store database 142 provides mass storage of the numerous digital products that are available for distribution (e.g. purchase or rental.) For example, digital products that have been purchased can be accessed from the product store database 142 over a communication network 110 by way of the product distribution site 132. Examples of digital products include digital media assets (e.g., media items) or computer products. Media items can pertain to music (e.g. songs or albums) or video (e.g., movies or television shows). Computer program products can pertain to applications (or application programs), animations, or presentations. Digital media assets can also include media bundles. Media bundles can include presentation configuration data, such as formatting instructions (or “specification instructions”), as well as metadata on various pieces of information present in media items. Media bundles can also include one or more media items.

The content submission module 134 receives submissions of digital media products from content providers, and the files within the submitted media bundle are stored separately. Specification instructions are stored within the specification database 144. In one embodiment, specification instructions can be provided in a markup language format. The markup language can, for example, be eXtensible Markup Language (XML.) In other embodiments, specification instructions may take the form of any formatted document containing a hierarchy. Specification instructions contain a series of elements for defining and configuring aspects of a presentation. An element within an XML or other formatted document can contain descriptive metadata, such as title, content provider name, distribution region, and media bundle size. Elements can also contain names of menu items, and a navigation structure for menus. If the media bundle is to include media items outside of the bundle file, such extra media items can also be identified in the descriptive metadata. For example, the extra media items can each be described by target path (or relative path) for the media item, content provider identifier, or file name. Elements can also contain global parameters for a presentation. In some embodiments, elements can contain object metadata, such as information about locations, actors, musicians, or objects within media items. In some embodiments, object metadata can be time-based, and the information can be linked to specific scenes or times within the media item.

Examples of elements in some embodiments that may be contained within specification instructions follow. The names, specifics, and definitions may vary from one embodiment to the next. An <extra> element can set global parameters for “extras” content within a media presentation. A <navnode> element can define the menu structure for navigation of a menu. A <rootnode> element can group territory-specific menu navigation structures. A <galleries> element can define image and video galleries within the extras content of a media presentation. A <scene_groups> element can contain a collection of scenes based around a theme, and a <scenes> element can define the scenes used within that collection of scenes.

Within each element, subelements can be contained that further define, format and instruct to create a media presentation. For example, within a <rootnode> element, multiple <territory> subelements can exist for specifying content that appears for individual territories, such as Mexico or the United States. Similarly, within a <galleries> element, subelements can exist for a <video> gallery and an <image> gallery, and further subelements can exist for specific gallery items. In this way, an embodiment of the present technology can include specification instructions that contain a hierarchical set of elements that instruct on how a media presentation should be presented to a user.

In some embodiments, in addition to specification instructions being separated from media bundles, the content submission module 134 also separates media items from media bundles into a media item database 146. The media item database 146 contains all media items that accompany media presentations and that are referenced in the specification instructions. Media items can include such content as images, videos, and director commentary audio tracks. Media items are often important elements making up the content for “extras” accompanying a purchased movie or audio product. For example, an animated feature-length film may contain “extra” content such as a concept art gallery, and a portion of the media items bundled in the media bundle can include the individual images of concept art that appear within the gallery. The specification instructions would specify the existence of the concept art gallery, the menu items denoting the concept art gallery, and the images that appear within the gallery. When the media items need to be accessed, they can be retrieved from the media item database 146. When the specification instructions need to be accessed, they can be retrieved from the specification database 144.

Once the digital product is received by the content submission module 134, and the specification instructions and media items are stored in the specification database 144 and media item database 146, respectively, the system can proceed to distribute content to users and optimize the content for specific client devices. In some embodiments, the media distribution server 125 includes a content distribution module 136. In alternative embodiments, the content distribution module 136 can be part of the optimization module 138. The content distribution module 136 communicates via the communication network 110 to send content to a requesting client device 105. A client device 105 accesses the media distribution server 125 and the product distribution site 132, which in some embodiments involves a user accessing a media store via a client device 105. Accessing the media store may require authenticating the user and client device 105, and verifying access privileges. The client device 105 then requests a digital media product from the product distribution site 105. At this point, the content distribution module 136 can send along the digital product to the client device 105, including the digital media asset and media bundle, which may include specification instructions and media items. In some embodiments, the client device 105 downloads and stores this content. In alternative embodiments, the client device 105 receives a stream containing a portion of the content, and further streams can be requested and received. In still other embodiments, a portion of the content is streamed and another portion of the content is downloaded and stored locally within the client device 105 for a combination of downloaded and stored playback. In some embodiments, the media presentation portions can be streamed from the media distribution server 125, while the digital media asset (such as a feature film) are downloaded and stored. Alternatively, the digital media asset portions can be streamed, while the media presentation portions are downloaded and stored.

The optimization module 138 can operate sequentially or in parallel with the content distribution module 136. While in the system embodiment 100, the optimization module 138 resides on the media distribution server 125, the optimization module 138 can reside on the client device 125, as part of the media player application 115 or as part of a separate client-side application, plug-in, or webpage. The optimization module 138 first detects the particular kind of client device 105 that is in operation, as well as the unique characteristics of the client device 105. The optimization module 138 may detect the particular kind of client device 105 as a laptop computer, a smart phone, a tablet, a digital media player that broadcasts to a television, or any conceivable client device that is capable of playing media content that is received from the media distribution server 125.

The unique characteristics of the client device 125 can include, in some embodiments, the screen dimensions, the screen resolution, the font size or amount of characters that is ideal to fit within the screen, the region or territory in which the client device 105 is being operated, the speed and bandwidth of the network connection the client device 105 is using, the operating system the client device 105 is using, and the types of user input the client device 105 is capable of receiving. With regard to the user input for a client device 105, for example, the optimization module 138 may consider it significant for optimization that the client device 105 is capable of responding to user gestures such as a “swipe” touch gesture. With regard to the operating system the client device 105 is using, for example, the optimization module 138 may consider it significant for optimization that the client device 105 is using an operating system with a specific aesthetic appearance, as well as user interface objects, transitions and metaphors that a user is accustomed to interacting with.

Once the optimization module 138 detects the kind of client device 105 in operation and the unique characteristics of the client device 105, the optimization module 138 receives the specification instructions for the media bundle that the user has requested from the specification database 144. To the extent that any media items are referenced in the specification database, the media items are received from the media item database 146. The optimization module 138 then translates the specification instructions into a specific media presentation, displayed in a way that is optimized for the particular kind of client device 105 and characteristics of the client device 105. For example, one media item which is presented for display may be a large, high-resolution image. Displaying the image on a client device 105 that is a smart phone may involve scaling down the resolution of the image to be optimal for the particular smart phone in operation, as well as scaling down the dimensions of the image to fit the small screen. Similarly, the optimization module 138 may utilize the touch gestures of a smartphone to enable a “swipe” gesture to display different images within an image gallery. The appearance and layout of the image gallery may also be optimized for the particular operating system, user inputs and screen dimensions of the client device 105. In this way, multiple optimization steps may be performed by the optimization module 138 according to various embodiments.

Finally, in embodiments where the optimization takes place on the media distribution server 125, the optimized media presentation and associated media files may be sent to the client device 105 for playback. In some embodiments, the media items and other files associated with the media presentation may be stored in a media content database 120 within the client device 105. The optimized media presentation may be played back by a user in an interactive format via the media player application 115, with media files and associated content being received and utilized from the media content database 120 as they are needed.

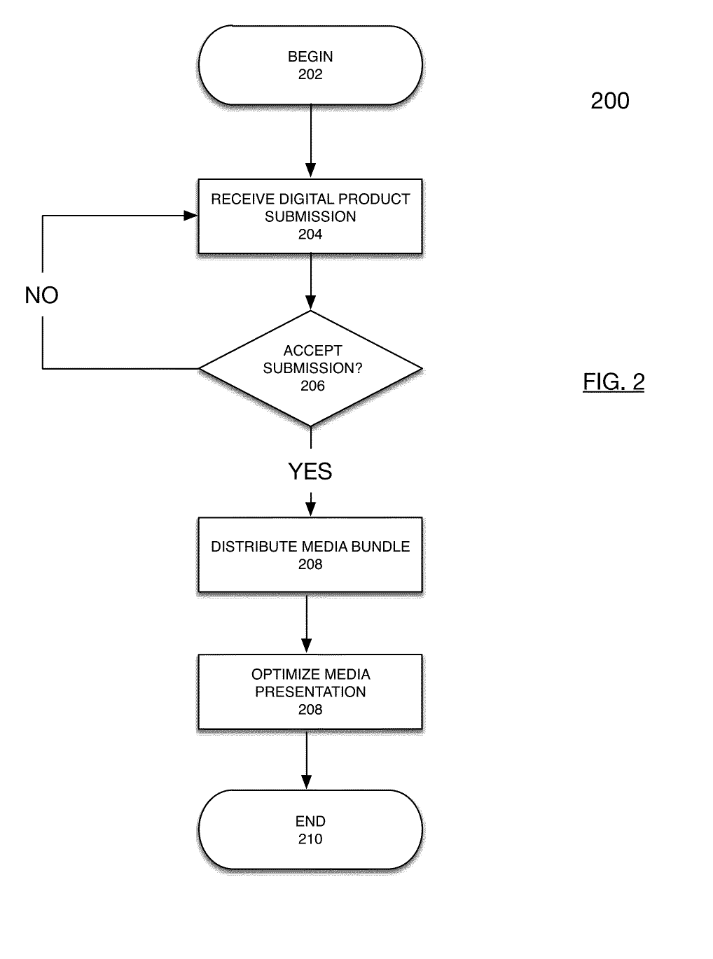

Turning now to FIG. 2, an operation of the media content submission, distribution and optimization processes will be discussed in greater detail. FIG. 2 is a flowchart of steps in an exemplary method 200 for optimizing media presentations for a client device. Method 200 begins at step 202 and continues to step 204. At step 204, the content submission module 134 within the media distribution server 125 receives a digital product submission from a content provider server 170. This step begins the content submission process, in which a content provider (i.e., a vendor) submits a digital content package, such as a feature length video, for inclusion within a media store. The digital product submission may contain, for example, a video file containing the feature length video for playback on various client devices 105, as well as a media bundle containing specification instructions and one or more accompanying media items for a media presentation.

At step 206, the submitted digital product is evaluated at the media distribution server 125 for whether it meets the standards of the media store. The standards and requirements for acceptance of a submitted digital product may vary for each media store. In some embodiments, the evaluation process is done near instantaneously, while in other embodiments the evaluation process may take a longer amount of time and may involve several evaluation substeps. If the submitted digital product is rejected, then the digital product is removed from consideration and subsequent submitted digital products are evaluated. If the submitted digital product is accepted, then the content distribution process can begin at step 208.

At step 208, the media bundle within the digital product is distributed by the content distribution module 136 to a client device 105 that has requested it from a product distribution site 132. In some embodiments, the content distribution module 136 will download the media content to a media content database 120 within the client device 105. In other embodiments, the content distribution module 136 streams the media content directly to a media player application 115 within the client device 105. In still other embodiments, some combination of streaming and downloading of the media content to the client device 105 occurs.

At step 208, the media presentation is optimized by the optimization module 138. As described above, this involves first detecting the kind of client device 105 in operation and various unique characteristics of the client device 105, and then optimizing the specification instructions and media items within the media bundle for optimized display within the client device 105.

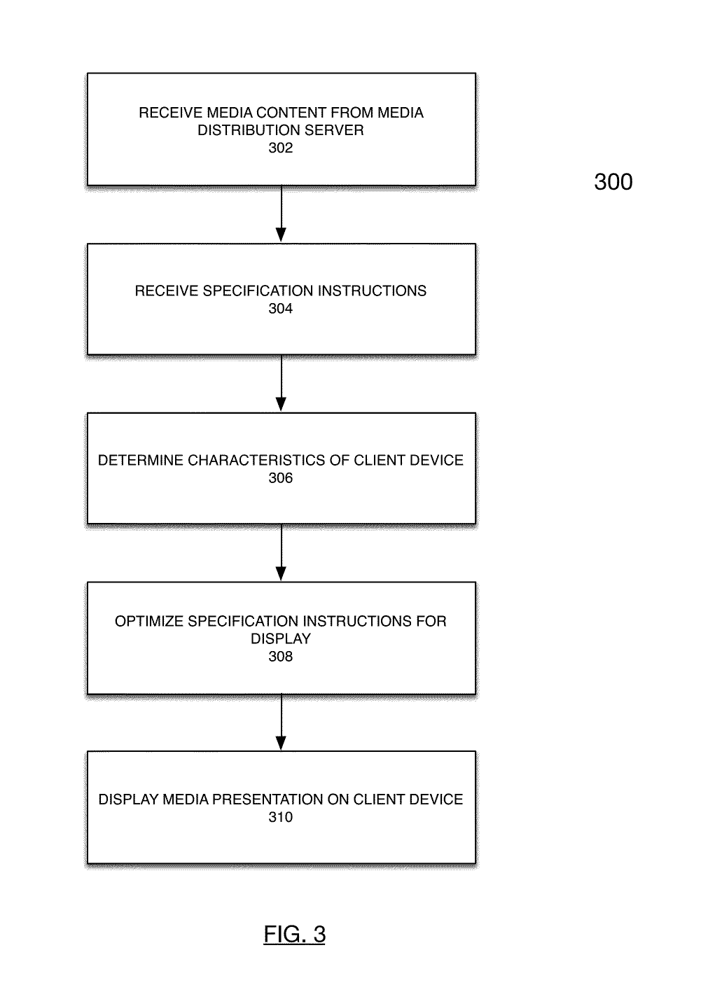

Now turning to FIG. 3, an operation of the optimization and display process will be discussed in greater detail. FIG. 3 is a flowchart of steps in an exemplary method 300 for receiving, optimizing and displaying media content on a client device.

At step 302, media content is received from the media distribution server 125. The media content may include, for example, a digital file containing a video for playback on a client device 105, as well as specification instructions and accompanying media items for a media presentation. The content can be retrieved from a product store database 142 containing media content from digital product submissions, a media item database 146 containing media items for a media presentation, or some combination of both.

At step 304, specification instructions are received from the media distribution server 125. The specification instructions can be retrieved from a specification database 144 containing all specification instructions from submitted media bundles.

Once both the relevant media content and specification instructions are received, the client device 105 which is accessing the media distribution server 125 can be analyzed. At step 306, the characteristics of the client device 105 are determined. The specific characteristics of the device to be analyzed will vary from embodiment to embodiment, and may include type of device, screen dimensions, user inputs and gestures available on the device, the region or territory in which the user is operating the device, and more.

At step 308, a media presentation is optimized for display on the client device 105 by presenting the elements of the media presentation in a way that is best suited to the client device 105's characteristics. As described above, a media presentation is formed by specification instructions specifying interactive media content such as navigable menus, as well as media items which may form the content of the media presentation. The optimization is performed according to the parameters that are best suited for the characteristics of the client device 105, which were determined in step 306 by analyzing the client device 105. The rules and parameters for optimizing each client device may vary from embodiment to embodiment.

One possible embodiment for providing rules and parameters for optimization includes providing pre-defined templates for the aspects of a media presentation. A template can be a specific, pre-defined way of presenting aspects of a media presentation that is understood by the optimization module 138. A template is designed to specify details on appearance, navigation, transitions, and other aspects of a media presentation in a way that is independent of which client device 105 a user is using. Within a set of specification instructions, <navnode> elements may declare a specific, pre-defined template to be used for displaying the navigation and appearance of that section of the media presentation. When the navigation node is rendered to the client device 105 by the optimization module 138, the template declared in the navigation node can be used to render the content in an appropriate way for the client device 105.

Finally, at step 310 the media presentation is displayed on the client device. The media presentation may be displayed through a media player application 115, which may be a client-side application, a browser plug-in, a webpage, or any number of conceivable playback devices.

An example of optimizing a media presentation follows. A Content Provider submits a digital package to an online media distribution site. The digital package contains an animated film in the form of a digital file. The digital package also contains an XML file containing specification instructions for a media presentation. The digital package also contains several media items constituting audio commentary tracks, language tracks in English, Spanish and French, images for a concept art gallery, and videos for a deleted scenes gallery.

The digital media store receives the submitted digital package, evaluates it, accepts it, and then stores the digital package in various databases within the digital media store servers. Some time later, a user browsing the media store comes across the digital package as one of the offerings in the media store. The user purchases the digital package from the media store, using a tablet computer.

In some embodiments, as the contents are downloaded, the digital media store's server or client's media player, an application on the tablet computer, or the combination of the two, can detect characteristics of the tablet computer. In some embodiments only an instruction file is downloaded initially allowing the client device to request the individual media items it will require rather than downloading the full package of content—some of which might not be relevant to the client device.

It may be detected that the user resides in the United States, is using English as a default, and is operating an iPad computer tablet running the latest operating system. Based on this information, the digital media store's server and/or the user's media player convert the XML file into instructions for a media presentation directed specifically toward the characteristics of the user's tablet. Since the user's region is the United States, English is selected as the default language, and content specific to the United States release of the animated film is presented to the user, including a title image that is in English. In addition, the images in the concept art gallery are resized and scaled down to fit the screen and resolution of the tablet. User gestures such as a finger “swipe” across the screen are implemented into the menu navigation controls. Several other optimizations are performed based on the specification instructions in combination with the characteristics of the client device. Finally, the end result is presented for playback on the user's tablet, as an interactive media presentation that loads when a user selects the digital package for playback.

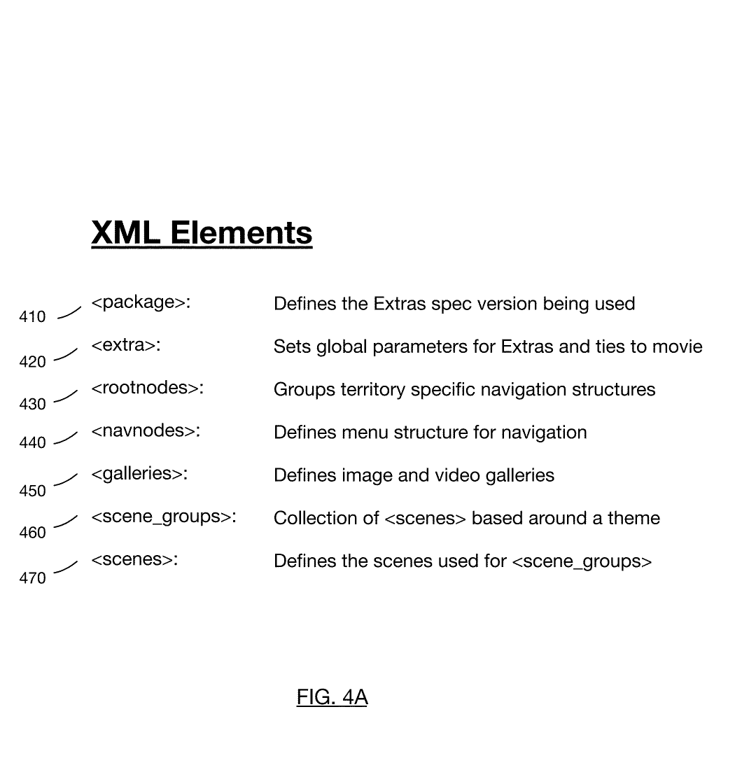

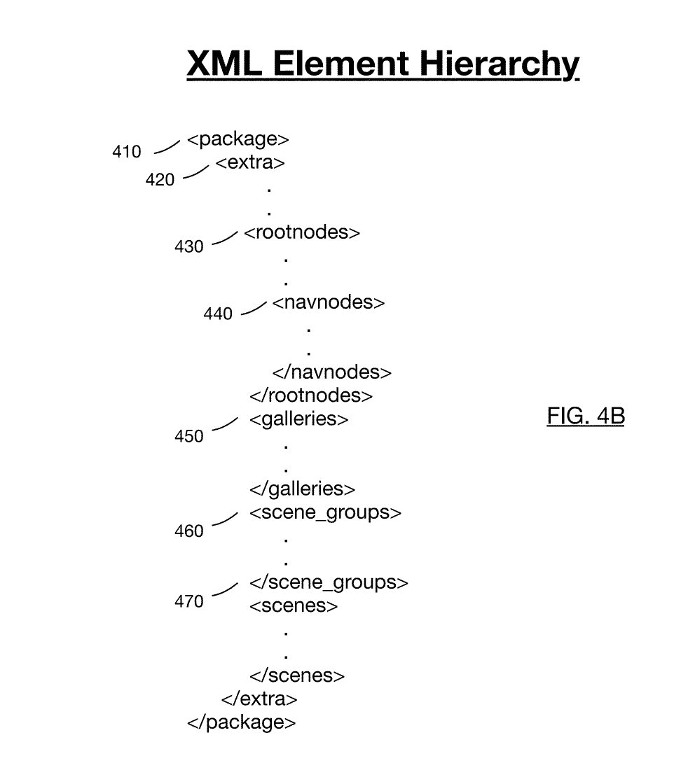

FIG. 4A illustrates an exemplary embodiment of a series of elements for creating a media presentation. Specification instructions contain several elements, denoted by specific words set within brackets. These elements are the building blocks for a media presentation. Several examples are noted in FIG. 4A and are explained below. As will be apparent to those of ordinary skill in the art when practicing the present technology other similar languages or schemes for providing such instructions and relationships between media items are possible.

The <package> element 410 defines the particular version of the specification instruction specification that is being used. The <extra> element 420 sets global parameters for the media presentation, and ties those parameters to the rest of the media content. For example, the package name, ID of the content provider, default language, and other parameters are tied to the movie file. The <rootnodes> element 430 groups territory specific navigation structures together. Rootnode elements can be used to create navigation elements that contain content to specific geographic regions, for example, content that only appears to users within the United Kingdom and United States. The <navnodes> element 440 defines the menu structure for navigation. A series of <navnodes> elements can specify a menu and submenus for a user to navigate within a media presentation. The <galleries> element 450 defines image and video galleries, and builds audio, video, and image components to be used in a media presentation. The <scene_groups> element 460 defines a collection of scenes based around a similar theme. This corresponds to different parts of a movie being classified within certain scene groupings. The <scenes> element 470 defines the individual scenes used within the <scene_groups> element 460. Several additional elements for additional aspects of a media presentation are expected and may be possible in some embodiments.

Navigation nodes, expressed through the <navnodes> element, may also be used to present alternate presentations of the main media content to a user. One example may be for a commentary track within a feature-length video. A navigation node entitled “Director's Commentary” is specified within a set of specification instructions in a media bundle. The audio, subtitles, and closed-captioning for a director's commentary track are included as media assets for the presentation, and are separate from the main content, but aligned to the timeline of the main content. These assets are delivered by a content provider as auxiliary parts of a feature-length film. The navigation node is identified within the specification instructions as a director's commentary, and includes the information for displaying a name and description to a user viewing the media presentation. It also includes information for presenting the set of assets to the user as an audio track that plays along with the video. In this way, the main video content can be re-used for many different alternate presentations. Another example of presenting an alternate rendition of main media content can include presenting a visual overlay, such as an alpha channel overlay with pop-up text related to individual scenes, on top of the main video content.

FIG. 4B illustrates an exemplary embodiment of an XML element hierarchy, in which elements and subelements specify instructions for an interactive media presentation. Within the XML element hierarchy, the XML elements described above in FIG. 4A are used.

Within the example XML element hierarchy 400, several nested elements appear within a <package> element 410. Within a package, an <extra> element 420 sets the global parameters for the media presentation. Several <rootnodes> elements 430 can then appear which group together territory-specific navigation structures. For example, a single <rootnodes> element 430 can contain territory-specific content for the United States. Within a <rootnodes> element 430, several <navnodes> elements 440 can appear which define menu structures for navigation within a territory.

Once the <rootnodes> elements 430 are specified, other elements can be presented. Multiple <galleries> elements 450 can appear which place image and video galleries within a presentation. In addition, <scene_groups> elements 460 can specify collections of scenes based around a theme, while <scenes> elements 470 can define the scenes used for those <scene_groups> elements 460.

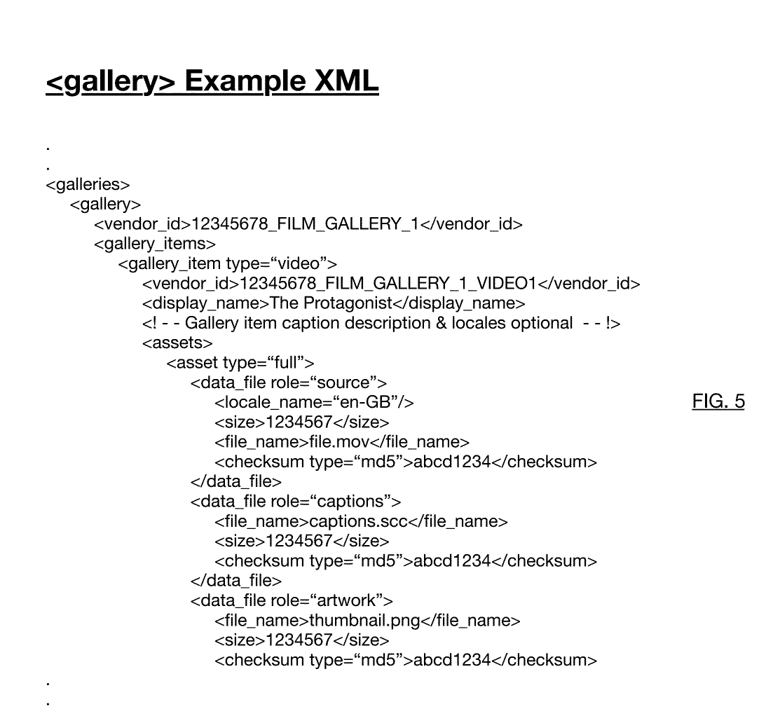

FIG. 5 illustrates one possible embodiment of a portion of an XML file that may be used to create a media presentation, using the example XML element hierarchy illustrated in FIG. 4. Within this portion of the example XML file, a video gallery is defined, and a video within the video gallery is defined and linked to an accompanying media item. Several pieces of metadata are defined, including content provider ID, the name of the video within the video gallery, and the size of the video file. While metadata and gallery items are defined, the formatting, user input, dimensions of media assets and other pieces of information are not specified by the XML file. These crucial parts of the media presentation are configured during the optimization process, and are suited to the particular client device being used. Such information is not included within the specification instructions.

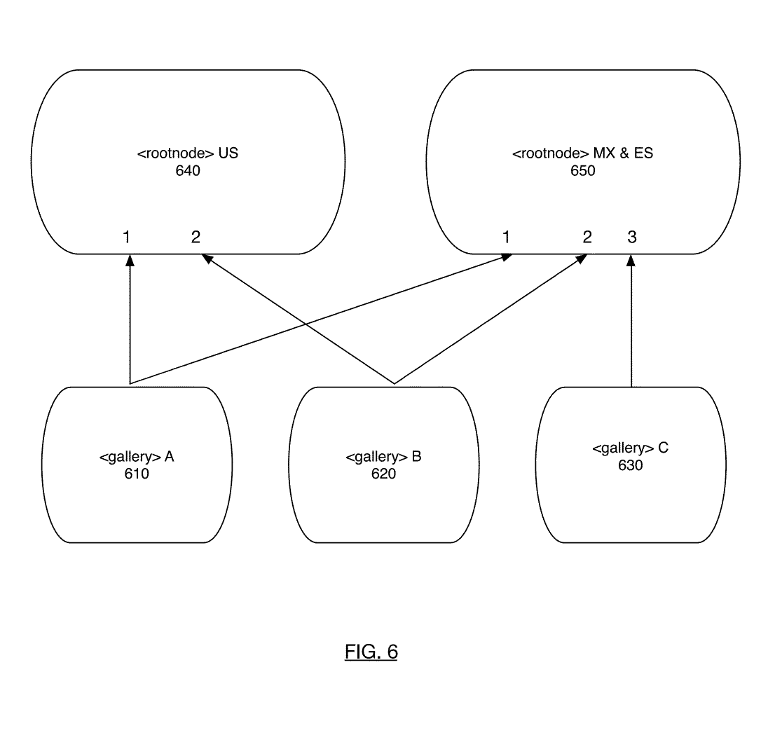

FIG. 6 illustrates one possible embodiment of mapping rootnodes within a set of specification instructions. As described above, a <rootnode> element can contain content specific to a set of geographical regions. In FIG. 6, The <rootnode> element 640 contains content specific to the United States. The <rootnode> element 650 contains content specific to Mexico and Spain. Each <rootnode> element can contain multiple nested <navnode> elements that specify the content for that set of geographical regions. In this possible embodiment, three <gallery> elements displaying image or video content have been defined. Navnodes map each gallery's content to rootnodes, in order to specify which geographical regions can access each gallery. In the mapping of the possible embodiment, navnodes connect gallery A 610 to the rootnode 640 for the United States as well as the rootnode 640 for Mexico and Spain. Users within any of the three geographical regions can navigate to and access gallery A 610. Similarly, gallery B 620 is mapped to both rootnodes. Users within any of the three geographical reigions can navigate to and access gallery B 620. In this example, gallery C 630 is mapped via navnode only to the rootnode 640 for Mexico and Spain, not to the rootnode 630 for the United States. Numerous reasons may exist to connect a gallery to some regions but not others. For example, the media content displayed in gallery C 630 may be cleared for use within Mexico and Spain, but not cleared for use within the United States.

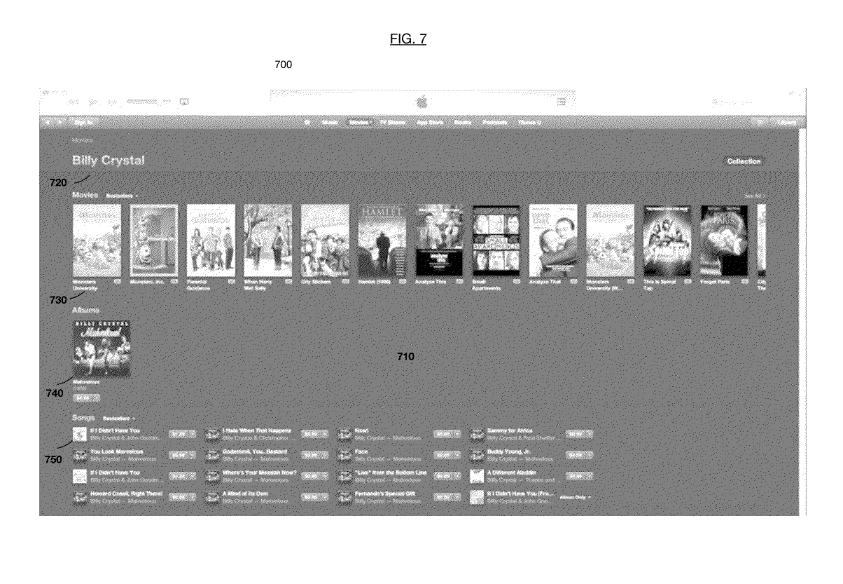

FIG. 7 illustrates one possible embodiment of tags being used within media items in an online store. Within a set of specification instructions, <tag> elements can be used to identify individuals associated with a piece of content. An actor or character can be tagged within a gallery, a scene, or in other places within a media presentation. When an actor or character is tagged, their content can be grouped together and associated with related content in the online store. All tags can use an identification number that is assigned to them across the online store. When a particular actor is tagged in a piece of media, that piece of media is grouped with other pieces of media in which the actor appears or is otherwise involved. An example of this can be illustrated with FIG. 7. The image 700 illustrates an example screenshot of a user session as the user interacts with the online store 710. Within the online store 710, a user can search for an actor or character. The user searches for the actor Billy Crystal, and results appear for the actor under the heading 720, marked “Billy Crystal”. A movie list 730 shows a list of movies in which Billy Crystal has been tagged. An album list 740 shows a list of albums in which Billy Crystal has been tagged. Finally, a song list 750 shows a list of albums in which Billy Crystal has been tagged. The user can browse across the various pieces of media which are presented in the online store, and investigate further, based on the <tag> elements in which an actor or character has been tagged. In this way, actors and characters are tagged across related content.

In some embodiments, tags can also be used for locations, objects and other pieces of data that may appear within galleries and scenes. Tags can also contain a time element. For example, a tag element may define an actor appearing within a scene, and also the specific time the actor appears within the scene. Time-based tags can then be used for different purposes such as searching for actors within particular scenes, or delivering extra content that is relevant to a scene.

FIG. 8A, and FIG. 8B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 8A illustrates a conventional system bus computing system architecture 800 wherein the components of the system are in electrical communication with each other using a bus 805. Exemplary system 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 500, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates a computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output 865, such as a display, and can read and write information to storage device 870, which can include magnetic media, and solid state media, for example. Chipset 860 can also read data from and write data to RAM 875. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 885 and execute appropriate functions, such as browsing functions by interpreting these inputs using processor 855.

It can be appreciated that exemplary systems 800 and 850 can have more than one processor 810 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

We claim:

1. A computer-implemented method comprising:
requesting, by a client device, from a server, a package of media items associated with a title;
receiving, by a client device, an instruction set for presenting a plurality of individual of media items from the package of media items;
processing the instruction set into optimized display instructions based on characteristics of the client device; and
presenting the media items according to the optimized display instructions.

2. The computer-implemented method of claim 1, wherein the optimized display instructions identify the individual media items with the package of media items and provide media item type data with respect to the individual media items.

3. The computer-implemented method of claim 1, wherein the processing the instruction set into optimized display instructions further comprises:
selecting a subset of the plurality of individual media items for presentation on the client device.

4. The computer-implemented method of claim 3, further comprising requesting the selected subset of the plurality of individual media items from the server.

5. The computer-implemented method of claim 4, wherein the requesting the selected subset of the plurality of the individual media items includes requesting individual media items formatted for the display attributes of the client device.

6. The computer-implemented method of claim 4, wherein the requesting the selected subset of the plurality of the individual media items includes requesting individual media items appropriate for a geographic attribute of the client device.

7. The computer-implemented method of claim 1, wherein the package of media items associated with a title is supplemental content associated with the title, and wherein the title is a movie, audio track, book, or other media title.

8. The computer-implemented method of claim 1, wherein the instruction set for presenting a plurality of individual of media items from the package of media items, includes an identification of individual media items, and a scheme for displaying the individual media items relative to each other.

9. The computer-implemented method of claim 1, wherein the instruction set includes time-based metadata elements.

10. A computer-implemented method, comprising:
receiving, by a media player application running on a client device, a plurality of media items;
receiving, by the media player application running on the client device, specification instructions for displaying a media presentation;
detecting, by the media player application running on the client device, characteristics of the client device;
optimizing, by the media player application running on the client device, the specification instructions based on the characteristics of the client device; and
displaying, by the media player application running on the client device, the media presentation based on the specification instructions.

11. The computer-implemented method of claim 10, wherein the optimizing the specification instructions includes resizing at least one of the plurality of media items to fit the client device.

12. The computer-implemented method of claim 10, wherein the optimizing the specification instructions includes adding touch input to the user input controls of the media presentation.

13. The computer-implemented method of claim 10, wherein characteristics of the client device include display characteristics of the client device.

14. The computer-implemented method of claim 10, wherein the specification instructions include a formatted set of parameters for a media presentation.

15. A non-transitory computer-readable storage medium having stored therein instructions which, when executed by the processor, cause the processor to perform operations comprising:
analyzing, by the processor, the display and usage characteristics of a client device;
formatting, by the processor, a set of media presentation elements according to the analyzed display and usage characteristics of the client device; and
presenting, by the processor, a media presentation according to the formatted set of media presentation elements.

16. The computer-readable medium of claim 15, wherein the formatting further includes creating a displayable navigation menu to fit within the screen of the client device.

17. The computer-readable medium of claim 15, wherein the display and usage characteristics of the client device include the screen dimensions of the client device.

18. The computer-readable medium of claim 15, wherein the presenting further includes preparing the media presentation for playback on a media device.

19. A media presentation optimization system, comprising:
a communications interface;
a processor; and
a computer readable medium, having stored thereon a plurality of instructions for causing the processor to perform operations comprising:
receiving, by a client device, a formatted set of instructions for presenting a plurality of media elements;
analyzing the client device to detect display and usage characteristics of the client device;
processing the formatted set of instructions into optimized display instructions based on the display and usage characteristics of the client device; and
presenting the media elements for playback on the client device according to the optimized display instructions.

20. The system of claim 19, wherein the plurality of media elements are digital multimedia assets within an interactive media presentation.

21. The system of claim 19, wherein the formatted set of instructions includes time-based metadata elements for a media presentation.

22. A computer-implemented method, comprising:
receiving, by a client device, a set of media elements to be presented within a media presentation;
receiving, by a client device, a formatted set of instructions for the set of media elements;
determining the screen size, user input and geographical region of the client device;
processing the formatted set of instructions into optimized display instructions, wherein the processing includes configuring the set of media elements to be compatible with the screen size, user input and geographical region of the client device; and
presenting the media elements for playback on the client device according to the optimized display instructions.

23. The computer-implemented method of claim 22, wherein the formatted set of instructions includes time-based metadata.

24. The computer-implemented method of claim 22, wherein presenting the media elements for playback further includes creating a menu for navigating the media elements.

25. The computer-implemented method of claim 22, wherein the media elements are digital multimedia assets within an interactive media presentation.
